(19) United States
(12) Patent Application Publication
(10) Pub. No.: US 2015/0230443 A1
(43) Pub. Date: Aug. 20, 2015

(54) FISHING LURE

(71) Applicant: Megabass Inc., Hamamatsu-shi (JP)

(72) Inventor: Koichi ITO, Hamamatsu-shi (JP)

(73) Assignee: MEGABASS INC., Hamamatsu-shi (JP)

(21) Appl. No.: 14/610,684

(22) Filed: Jan. 30, 2015

(30) Foreign Application Priority Data
Feb. 17, 2014 (JP) 2014-027898

(51) Int. Cl. A01K 85/16; A01K 85/00

(52) U.S. Cl. CPC A01K 85/16; A01K 85/00

(57) ABSTRACT

A lure has a lip properly slanted down forward which is attached in a neighborhood of a front end portion of a lure body that is formed to have an external appearance imitating a small fish. A head section of the lure body is formed to have a tapered thin edge shape in top view.

### CROSS-REFERENCE TO RELATED APPLICATIONS

This application is based upon and claims the benefit of priority of the prior Japanese Patent Application No. 2014-027898, filed on Feb. 17, 2014, the entire contents of which are incorporated herein by reference.

### BACKGROUND OF THE INVENTION

1. Field of the Invention

The Present invention relates to a fishing lure, particularly to a crankbait lure which has a lip in a neighborhood of a front end portion of a lure body.

2. Description of the Related Art

In lure fishing, lures of various shapes and devices according to a type or the like of a target fish have been devised. For example, when a large fish called a fish eater which mainly eats a small fish as diet is the target fish, a lure with a shape imitating a small fish is used. Devices on shapes or colors of the lure have been made to attract the target fish, in other words, in order to obtain a fish attracting effect to strongly appeal to the target fish.

In an appealing effect to the target fish in the lure of such a type, not only the shape but also a lure action of the lure during moving in the water is also an important point. For example, a lure which has a lip (diving plate) provided in a neighborhood of a front end portion of a lure body in particular is configured to draw a move trace while making a lure action by receiving a stream resistance with the lip during moving. For example, a lure described in Patent Document 1 has a lip which has a plate structure protruding from a lure main body. [Patent Document 1] Japanese Laid-open Patent Publication No. 2004-57203

Incidentally, the crankbait lure generally attracts a fish by the lure moving along a linear path, but a range in which the lure can appeal to the fish by being casted once is small because of the linear path. Increased number of casting is inevitable in order to appeal to the fish broadly. Further, a move trace of the lure along the linear path is simple, and the way the lure approaches a staying fish or the way the lure runs away therefrom, for example, is easy for the fish to know, which affects the appealing effect.

### SUMMARY OF THE INVENTION

In consideration of the above-described circumstances, an object of the present invention is to provide a fishing lure exhibiting an excellent appealing effect to a fish.

A fishing lure of the present invention is a fishing lure with a lure body formed to have an external appearance imitating a small fish, and the fishing lure has a lip properly slanted down forward which is attached in a neighborhood of a front end portion of the lure body, wherein a head section of the lure body is formed to have a tapered thin edge shape in top view.

Further, in the fishing lure of the present invention, a recessed portion is formed in an upper surface of the head section of the lure body.

Further, in the fishing lure of the present invention, a base of the lip joined to the lure body is formed to continue linearly from a front end portion of the lip and is joined as it is to the lure body.

Further, in the fishing lure of the present invention, a base of the lip joined to the lure body is formed in a manner that both sides of the base are raised properly upward.

### BRIEF DESCRIPTION OF THE DRAWINGS

FIG. 1 is a perspective view of a fishing lure according to an embodiment of the present invention;

FIG. 2A is a front view of the fishing lure according to the embodiment of the present invention;

FIG. 2B is a top view of the fishing lure according to the embodiment of the present invention;

FIG. 3A is a top view showing a periphery of a head section in the fishing lure according to the embodiment of the present invention;

FIG. 3B is a top view showing an action by the head section in the fishing lure according to the embodiment of the present invention;

FIG. 4 is a plan view showing an example of a move path of the fishing lure according to the embodiment of the present invention;

FIG. 5A is a top view showing a periphery of a head section in a common fishing lure;

FIG. 5B is a perspective view showing an action by the head section in the common fishing lure;

FIG. 6 is a plan view showing an example of a move path in the common fishing lure;

FIG. 7 is a side view of the fishing lure according to the embodiment of the present invention;

FIG. 8A is a side view for explaining a wobbling motion in the fishing lure according to the embodiment of the present invention;

FIG. 8B is a top view for explaining the wobbling motion in the fishing lure according to the embodiment of the present invention;

FIG. 9A is a top view for explaining a rolling motion in the fishing lure according to the embodiment of the present invention;

FIG. 9B is a front view for explaining the rolling motion in the fishing lure according to the embodiment of the present invention; and

FIG. 10 is a perspective view showing a joining structure of a lip base in the common fishing lure.

### DETAILED DESCRIPTION OF THE PREFERRED EMBODIMENTS

Hereinafter, a preferred embodiment of a fishing lure according to the present invention will be described in detail based on the attached drawings.

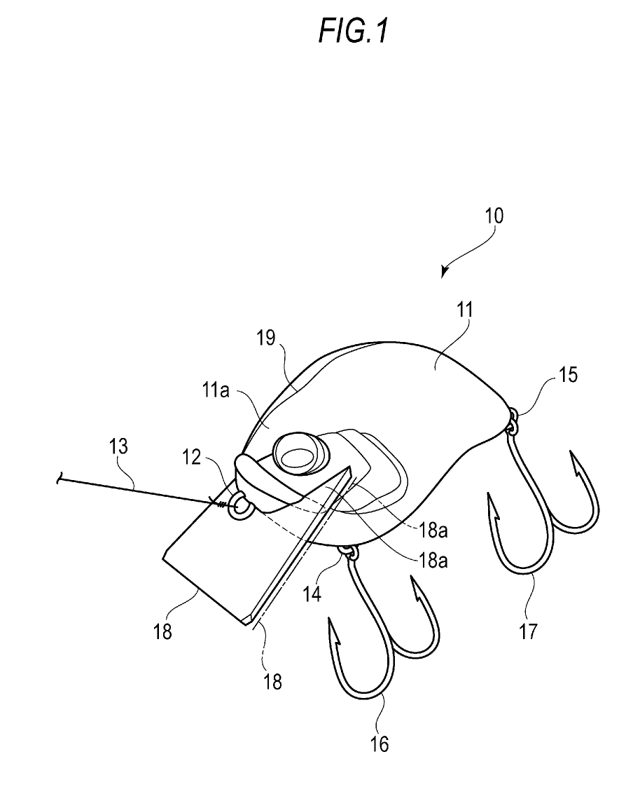

FIG. 1 shows an example of a fishing lure 10 in this embodiment. In FIG. 1, a reference numeral 11 indicates a lure body, and this lure body 11 is formed to have an external shape imitating a small fish from a material such as a synthetic resin. In this case, right and left two body halves divided along a longitudinal direction (front and rear direction) of the lure body 11 are abutted on each other to be integrated, and the lure body 11 has a hollow structure.

Further, a reference numeral 12 indicates a line loop provided in a front end portion of the lure body 11, and a fishing line or a line 13 is tied to this line loop 12. Further, reference numerals 14 and 15 each indicate a hook hanger, and a front hook (fishing hook) 16 and a rear hook 17 are engaged thereto. Note that a balance weight made normally of metal is embedded inside the lure body 11 as necessary. As the balance weight, there can be included a single or a plurality of balance weight(s) fixed to (a) predetermined position(s) of the lure body 11, or balance weight(s) movable along the longitudinal direction of the lure body 11, and so on.

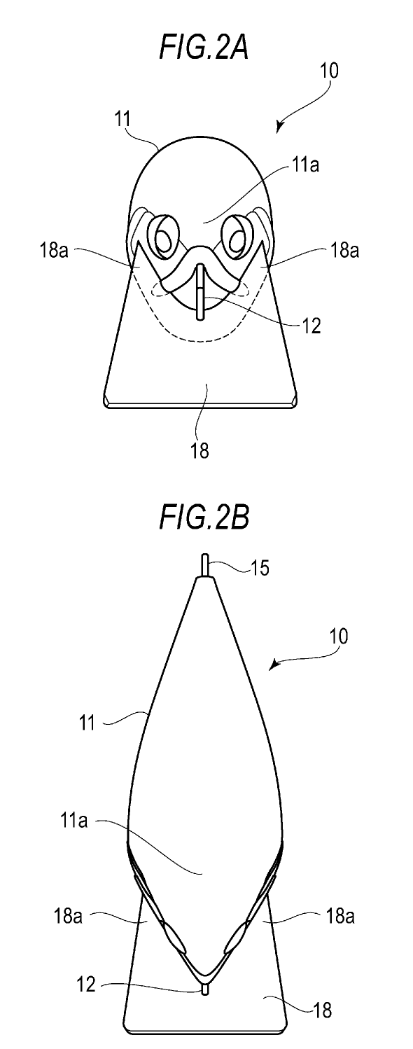

Further, a reference numeral 18 indicates a lip (diving plate) attached in a neighborhood of the front end portion of the lure body 11. The lip 18 is formed to have a thin plate shape and is provided to be slanted downward (typically slanted down forward) properly in relation to the lure body 11. As shown in FIG. 2A, the lip 18 is formed to have a trapezoidal shape whose base on a front end side is a larger base. Thereby, pulling the line 13 can cause the lure 10 to take a diving posture.

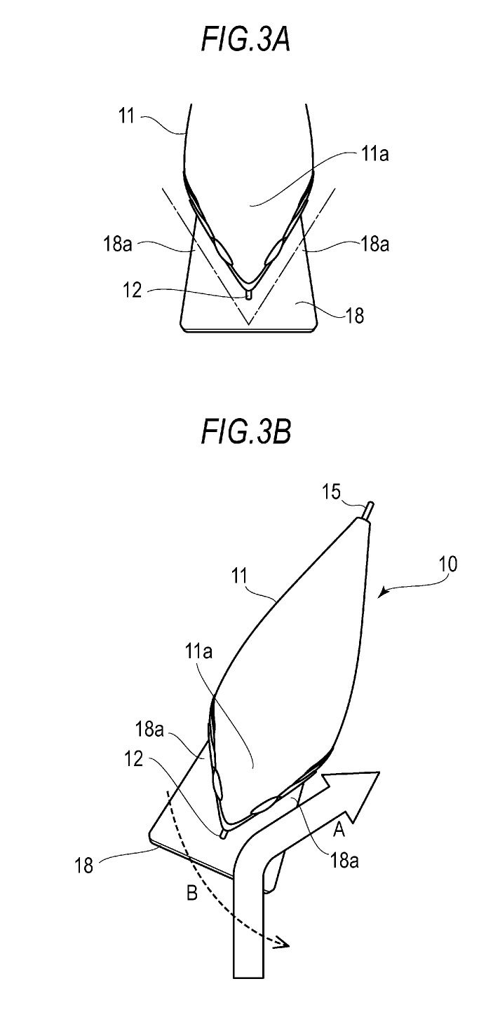

In the lure 10 of the present invention in particular, a head section 11a of the lure body 11 is formed to have a tapered thin (narrow) edge shape in top view as shown in FIG. 2B, and has a V-letter shape as shown by an illustrated example. The head section 11a is edged and pointed as indicated by a dashed line of FIG. 3A, and thus, when a head part is shaken to either right or left on receiving a stream, the head section 11a receives the stream by only one side of right and left sides as indicated by an arrow A of FIG. 3B (left side of the lure body 11), for example. It becomes difficult to turn toward an opposite side (left side viewed from the lure 10) to that one side, that is, it becomes difficult to swing as indicated by a dotted line arrow B of FIG. 3B, and the lure 10 flows in a manner to point to the right. By having an edged shape, the lure 10 becomes easy to grasp water received from a traveling direction as shown in FIG. 3B, to move while changing a direction to either right or left similarly to in a case of turning a rudder of a boat.

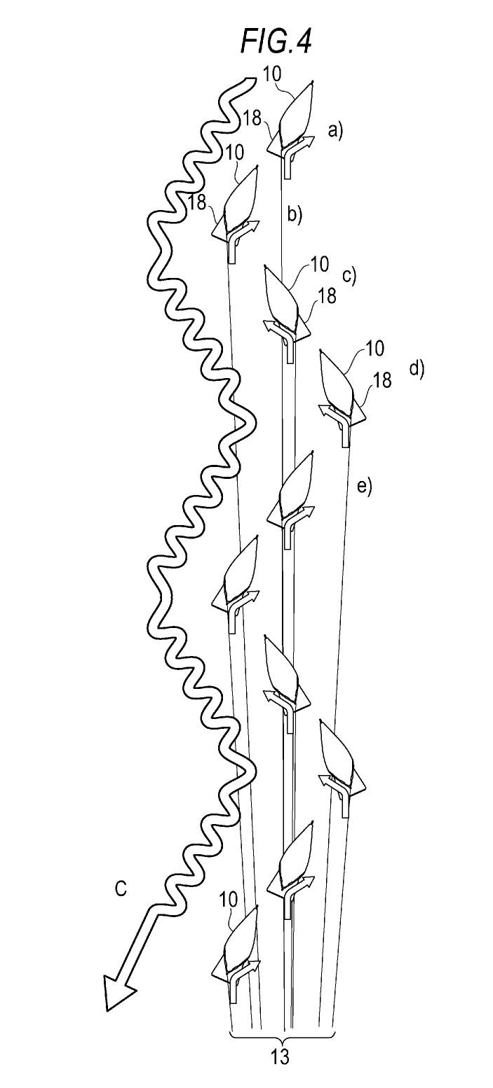

FIG. 4 is a plan view showing an example of a move path of the lure 10. When the line 13 is pulled in relation to the lure 10 in the water, the lure 10 moves pointing either right or left (state of a) of FIG. 4). Since the lure 10 proceeds while being pulled by the line 13, when proceeding in an oblique direction (state of b) of FIG. 4) for some distance, a force of an opposite lateral direction to a pointing direction acts on the lure 10 from the line 13. Due to this force of the opposite lateral direction, the lure 10 changes the direction from the former direction and moves (state of c) of FIG. 4). Further, when changing the direction and proceeding in the oblique direction for some distance (state of d) of FIG. 4), a lateral force of an opposite direction to the above acts, and the lure 10 changes the direction again (state of e) of FIG. 4). Hereinafter, similar motions are repeated.

The move path of the lure 10 obtained by the above motions has a large S-letter shape as indicated by a heavy line arrow C of FIG. 4, that is, the lure 10 performs a lure action of a slalom shape. At a time of the lure action of the slalom shape of the lure 10, a move path as a whole shows a slalom form of the S-letter shape, making an action of quivering right and left.

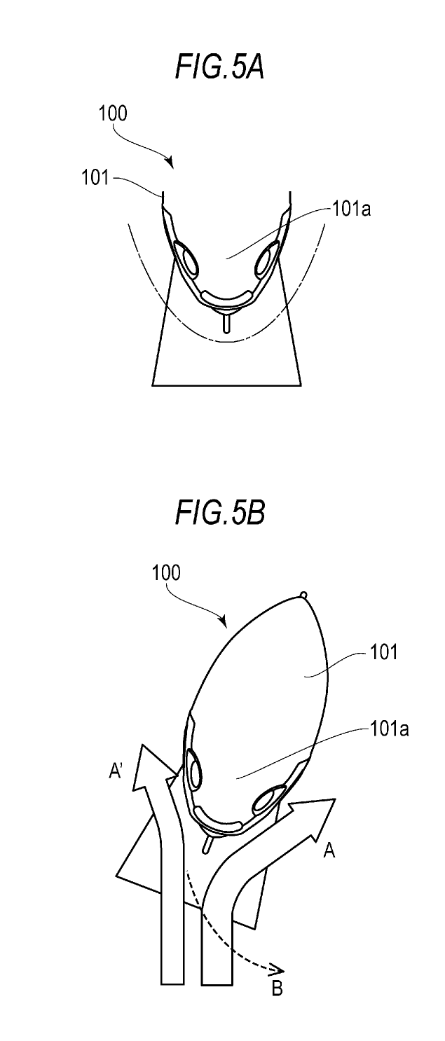

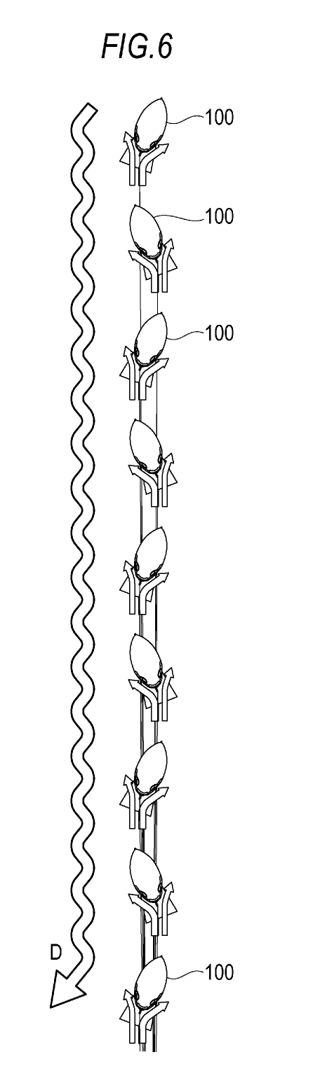

Here, with regard to a shape of a periphery of a head section of a lure body in a common lure, with reference to FIG. 5A for example, a head section 101a of a lure body 101 of a lure 100 is formed curvedly to have an R-shape in top view as indicated by a dashed line of FIG. 5A. In a case where the head section 101a is round as above, when receiving a stream and shaking a head part to either right or left, the lure body also receives a stream as an arrow A′ on an opposite side to an arrow A of FIG. 5B, for example. In other words, since the lure body 101 receives the streams on both right and left sides thereof, the lure body 101 becomes easy to turn to the opposite side, that is, becomes easy to shake head as indicated by a dotted line arrow B of FIG. 5B, resulting in a straight move path of the lure 100 as indicated by a heavy line arrow D of FIG. 6. The lure 100 which has a round head region shape becomes easy to parry water received from a traveling direction, easily changing directions while acting with a tremble without having directivity as in the present invention, and basically does not perform a lure action of a slalom shape as in the present invention.

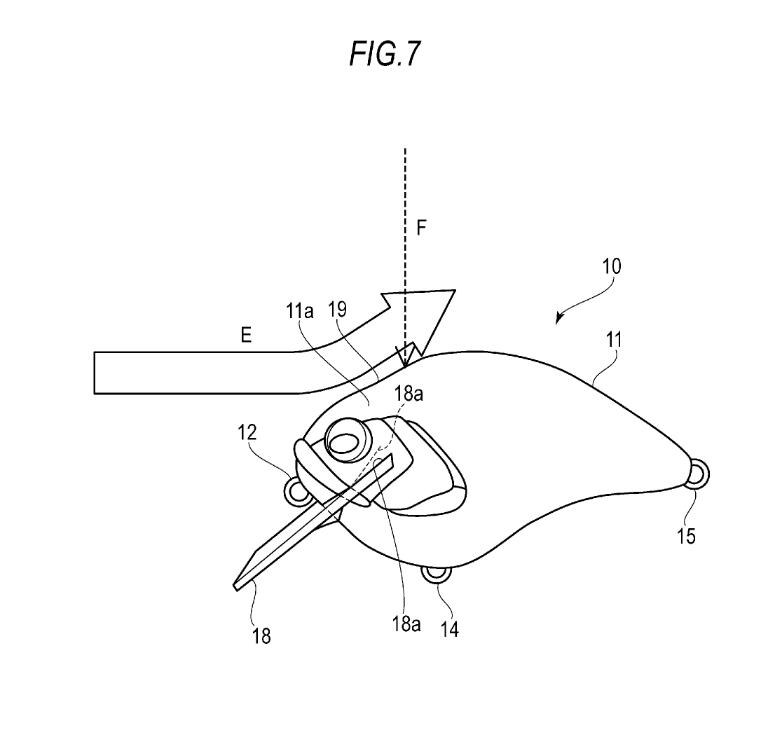

Further, as shown in FIG. 7, a recessed part 19 is formed in an upper surface (near a forehead part to a head part) of the head section 11a of the lure 10. This recessed part 19 is positioned slightly obliquely rear upward of an eye part, and receives water flowing from the front in the traveling direction toward obliquely rear upward as indicated by an arrow E in FIG. 7 when the lure 10 starts moving. By such a stream, the lure body 11 is pressed from up to down as indicated by an arrow F near the recessed part 19, upward movement being suppressed, and becomes easy to tilt to either right or left.

As described above, the lure 10 performs the slalom-shaped lure action by retrieving of the line 13, and at start of moving of the lure 10, the recessed part 19 receiving water facilitates diversion of the move path to right and left. The recessed part 19 effectively works to cause the slalom-shaped lure action in the lure 10.

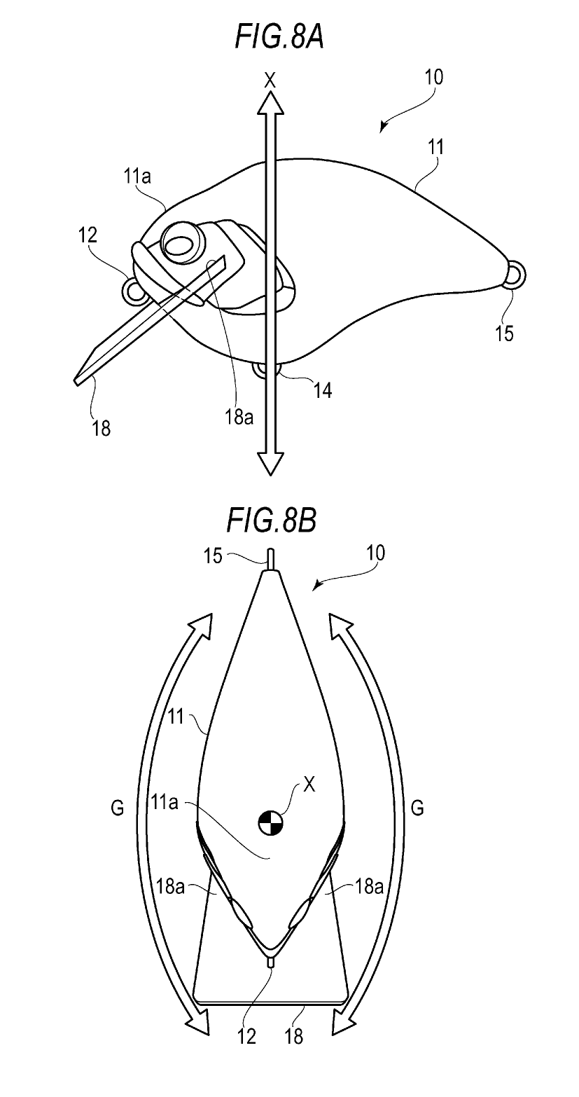

Further, the slalom-shaped lure action of the lure 10 is closely related to a wobbling motion, that is, wobbling is prerequisite for a crankbait lure making a slalom action. Here, as shown in FIG. 8A and FIG. 8B, in wobbling, a motion is made as indicated by an arrow G around an axis (referred to as a wobbling axis X) penetrating the lure body 11 in an up and down direction. Operation and effect by the edged shape in the head section 11a of the lure body 11 and the recessed part 19 described above function effectively only by the wobbling motion in which water is actively received from a front of the lure body 11.

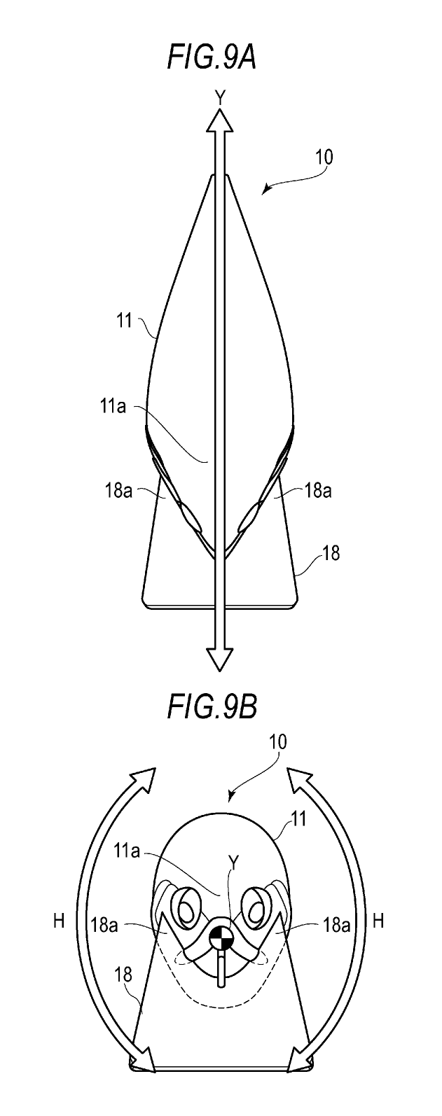

In this case, water is parried in a rolling action, which becomes a disturbing factor of the slalom-shaped lure action. Note that as shown in FIG. 9A and FIG. 9B, in rolling, a motion is made as indicated by an arrow H around an axis (referred to as a rolling axis Y) penetrating the lure body 11 in a front and rear direction. Such a rolling motion as it is cannot bring out the effect obtained from the edged shape in the head section 11a or the recessed portion 19 effectively.

Thus, in the lure 10 of the present invention, further, a base 18a of the lip 18 joined to the lure body 11 is formed to continue linearly from a front end portion of the lip 18 and joined as it is to the lure body 11 (see FIG. 1). In other words, a joining portion of the lure body 11 and the lip 18 is preferable to have a joining structure in which the flat lip 18 is only inserted into the lure body 11. Configuring the base 18a of the lip 18 as above makes water received by the lip 18 hard to be parried by a root portion of the lip 18, and as a result of generating a wobbling motion thereby, the slalom action can be surely induced.

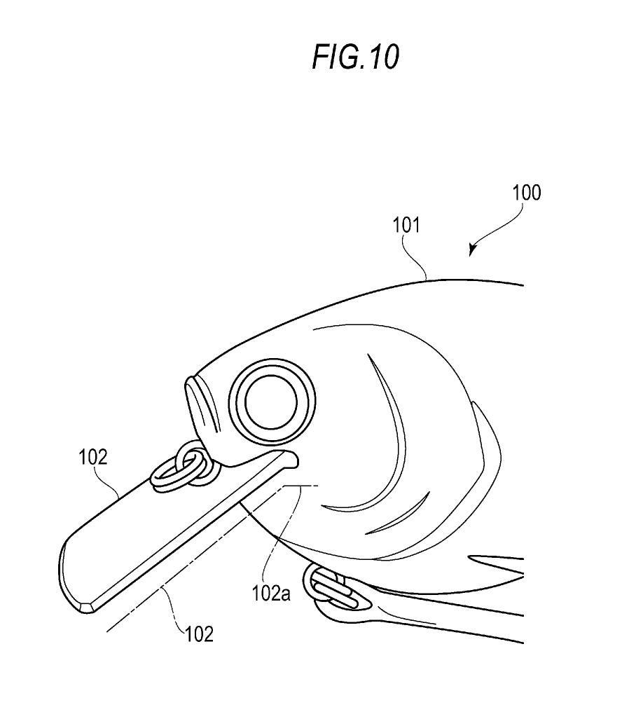

Explanation will be performed by a case of a lure 100, for example, as shown in FIG. 10. As indicated by a dashed line shape of FIG. 10, if a base 102a of a lip 102 is bent and joined to a lure body 101, the above bent portion causes water to evade and brings about a rolling motion. It becomes practically difficult to induce a slalom action from the rolling action.

Next, operation and effect and so on in the fishing lure 10 of the present invention constituted as above will be described. After the casted lure 10 hits the water, by the line 13 being pulled, the lip 18 receives a stream resistance and dives in a forward tilting posture. In such a case, by adjusting a pulling strength or the like of the line 13, it can be controlled so that the lure body 11 takes a desired lure action.

The common lure 100 attracts a fish along a linear move path as described above, while the lure 10 of the present invention, since having a swing width in a lateral direction because of a lure action along an S-letter shaped move path in particular, can broadly appeal to a fish by being casted once. In other words, it is possible to attract not by a line but by a surface formed by an S-letter shape, and the number of casting at a target point can be decreased and the fish does not get weary, so that high catch can be expected.

Further, according to the S-letter shaped move path, the action appears and disappears, being able to be seen or not being able to be seen from eyes of the fish approaching from behind the lure 10, to make the fish easy to bite reflectively. The catch can be expected also in this point. Further, for a staying fish, in a case of the linear move path, the way the lure approaches the fish or escaping from the fish is easy to know, which is poor in visual stimulation, and catch is hard to be expected. In the lure 10 of the present invention, since the move path has the S-letter shape, it is possible to obtain a visual effect that the lure suddenly appears in front of the fish or disappears.

Further, in the lure 10 of the present invention, when the fish having found the lure 10 starts to follow, the action of escaping right and left is made, which stirs a hunting instinct of a fish eater even more.

Further, since the lure 10 changes the move path to right and left while slightly tilting the lure body 11 when the lure 10 moves drawing the S-letter shaped move path, a blinking effect of colors applied on the lure 10 is significantly larger compared with the lure attracting linearly.

Note that though the preferred embodiment of the present invention has been described, the present invention is not limited to the aforementioned embodiment, but can be modified and so on as necessary.

Though an example of a trapezoidal shape is described as the shape of the lip 18, other than the illustrated example, roundness can be applied to corners of the trapezoidal shape, or not only the trapezoidal shape but also another shape is possible.

Further, as indicated by the dotted line in FIG. 7, the base 18a of the lip 18 can be formed in a manner that both sides thereof are raised properly upward so that water is made flow obliquely rear upward by this base 18a, to obtain an effect to press the lure body 11 from up to down.

According to the present invention, since there is a swing width in a lateral direction because of a lure action along an S-letter shaped move path, it is possible to appeal to a fish broadly by being casted once. In other words, it is possible to attract not by a line but by a surface formed by an S-letter shape, and the number of casting at a target point can be decreased and the fish does not get weary, so that high catch can be expected.

It should be noted that the above embodiments merely illustrate concrete examples of implementing the present invention, and the technical scope of the present invention is not to be construed in a restrictive manner by these embodiments. That is, the present invention may be implemented in various forms without departing from the technical spirit or main features thereof.

What is claimed is:

1. A fishing lure with a lure body formed to have an external appearance imitating a small fish, the fishing lure comprising:
a lip properly slanted down forward, the lip being attached to a neighborhood of a front end portion of the lure body,
wherein a head section of the lure body is formed to have a tapered thin edge shape in top view.

2. The fishing lure according to claim 1,
wherein a recessed portion is formed in an upper surface of the head section of the lure body.

3. The fishing lure according to claim 1,
wherein a base of the lip joined to the lure body is formed to continue linearly from a front end portion of the lip and is joined as it is to the lure body.

4. The fishing lure according to claim 2,
wherein a base of the lip joined to the lure body is formed to continue linearly from a front end portion of the lip and is joined as it is to the lure body.

5. The fishing lure according to claim 1,
wherein a base of the lip joined to the lure body is formed in a manner that both sides of the base are raised properly upward.

6. The fishing lure according to claim 2,
wherein a base of the lip joined to the lure body is formed in a manner that both sides of the base are raised properly upward.
